(19) United States
(12) Patent Application Publication
(10) Pub. No.: US 2025/0135474 A1
(43) Pub. Date: May 1, 2025

(54) Hydrodynamic Bathing Shower and Bathing Method

(71) Applicant: Shenzhen Aisi Forest Technology Co., Ltd, Shenzhen (CN)

(72) Inventor: Chengchun Li, Shenzhen (CN)

(73) Assignee: Shenzhen Aisi Forest Technology Co., Ltd, Shenzhen (CN)

(21) Appl. No.: 18/384,889

(22) Filed: Oct. 30, 2023

(51) Int. Cl. B05B 3/04; A46B 11/06; A46B 13/00; A46B 13/06; A47K 7/04; B08B 1/00; B08B 1/04; B08B 3/04

(52) U.S. Cl. CPC B05B 3/0422; A46B 11/063; A46B 13/008; A46B 13/06; A47K 7/046; B08B 1/12; B08B 1/32; B08B 3/04; A46B 2200/1006

(57) ABSTRACT

A hydrodynamic bathing shower and a bathing method comprises a main body shell, a driving component arranged in the main body shell and a cleaning component detachably attached to the main body shell, the driving component comprises a gear transmission mechanism, an impeller and a connecting part, the impeller and the gear transmission mechanism form a transmission connection, the gear transmission mechanism forms a transmission connection with the cleaning component through the connecting part, the main body shell is provided with at least one water inlet channel and water outlet channel, the method comprise: using this device for bathing.

### TECHNICAL FIELD

The present invention relates to the technical field of showers, in particular to a hydrodynamic bathing shower and a bathing method.

### BACKGROUND

Shower is the main bathroom product used for shower in daily life. At present, the most commonly used are ordinary showers with water outlet function. The traditional shower structure includes a handle part and a head part, the head part is arranged at the upper end of the handle part, the inner cavity of the handle part is communicated with the inner cavity of the head part, the head part is provided with a water outlet panel with a plurality of water outlet holes, and the lower end of the handle part is connected with a water source, so that the shower can be carried out when the water source is turned on. However, with the improvement of the quality of life, there are more and more requirements for the functions and performance of daily necessities. The traditional shower cannot satisfy people's pursuit of quality of life.

Therefore, there is an electric motor-type bathing brush in the market, which drives the bristles to rotate through the built-in motor, so that the bathing quality is improved. However, this kind of product contains electrical components, with complex structure, high waterproof requirements and single function, and the electric motor-type bathing brush needs to replace the battery frequently or provide power through wires, so it needs a higher waterproof level. All these problems have affected the user's bathing experience to some extent.

Based on the above problems, it is necessary to put forward a new type of bathing shower to meet people's quality pursuit. The bathing shower can drive the brush head to rotate without relying on electric energy, and has simple structure, multiple bathing functions and low production cost.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present invention provides a hydrodynamic bathing shower, which includes a main body shell, a driving component arranged inside the main body shell, and a cleaning component detachably attached to the main body shell.

Wherein, the driving component includes a gear transmission mechanism, an impeller and a connecting part, wherein the impeller and the gear transmission mechanism form a transmission connection, and the gear transmission mechanism forms a transmission connection with the cleaning component through the connecting part;
wherein, the main body shell is provided with at least one water inlet channel and at least one water outlet channel, and the impeller is arranged in the water outlet channel, wherein a water flow direction of the water inlet channel faces blades of the impeller;
wherein, when an external water source flows towards the water outlet channel through the water inlet channel, the impeller will be driven to rotate by the water flow, thereby driving the cleaning component to rotate.

The present invention provides a hydrodynamic bathing shower, which includes a main body shell, a driving component arranged inside the main body shell, and a cleaning component detachably attached to the main body shell;
wherein, the driving component comprises a gear transmission mechanism, an impeller and a connecting part, wherein the gear transmission mechanism comprises at least one gear transmission part and a gear box, and the gear transmission part is sleeved in the gear box, wherein the gear transmission part comprises at least one gear and at least one gear transmission shaft, wherein one end of the gear transmission shaft is fixedly connected with the impeller to form a transmission connection with the gear transmission mechanism, and the other end of the gear transmission shaft is provided with a connecting part;
wherein, the main body shell is provided with at least one water inlet channel and at least one water outlet channel, and the impeller is arranged in the water outlet channel, wherein a water flow direction of the water inlet channel faces blades of the impeller;
wherein, when an external water source flows towards the water outlet channel through the water inlet channel, the impeller will be driven to rotate by the water flow, thereby driving the cleaning component to rotate.

The present invention also provides a bathing method, which includes providing a hydrodynamic bathing shower, comprising a main body shell, a driving component arranged inside the main body shell, and a cleaning component detachably attached to the main body shell;
wherein, the driving component comprises a gear transmission mechanism, an impeller and a connecting part, wherein the impeller and the gear transmission mechanism form a transmission connection, and the gear transmission mechanism forms a transmission connection with the cleaning component through the connecting part;
wherein, the main body shell is provided with at least one water inlet channel and at least one water outlet channel, and the impeller is arranged in the water outlet channel, wherein a water flow direction of the water inlet channel faces blades of the impeller;
wherein, when an external water source flows towards the water outlet channel through the water inlet channel, the impeller will be driven to rotate by the water flow, thereby driving the cleaning component to rotate;
the method comprises the following steps:
installing the hydrodynamic bathing shower at a proper position;
communicating the hydrodynamic bathing shower with an external water source;
turning on the water source to make the water flow from the water outlet channel to the blades, and the blades rotating under the action of the water flow, so as to drive the gear transmission mechanism and the cleaning component to rotate, and the water flow being sprayed outwards from the cleaning component, so as to perform bathing while showering; and
turning off the water source after use.

### BRIEF DESCRIPTION OF DRAWINGS

In order to explain the technical solution of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic diagram of the overall structure of the hydrodynamic bathing shower;

FIG. 2 is a structural schematic diagram of the driving component;

FIG. 3 is a schematic diagram of the principle structure of the rotation of the driving component;

FIG. 4 is a schematic diagram of the connection between the gear box and the gear transmission mechanism;

FIG. 5 is a schematic diagram of the connection between the first gear transmission part and the second gear transmission part;

FIG. 6 is a schematic diagram of the explosion structure of the first gear transmission part;

FIG. 7 is a schematic diagram of the explosion structure of the gear transmission shaft;

FIG. 8 is a schematic diagram of the explosion structure of the second gear transmission part;

FIG. 9 is a structural schematic diagram of the bearing;

FIG. 10 is a structural schematic diagram of a spur internal gear;

FIG. 11 is a schematic diagram of the connection structure between the shower and the main body shell;

FIGS. 12A-12B are schematic diagrams of the connection structure between the brush head and the connecting part;

FIG. 13 is a schematic structural diagram of the water outlet channel;

FIG. 14 is a schematic structural diagram of the switch;

FIG. 15 is a schematic structural view of the cover;

FIG. 16 is a schematic structural view of the connection between the first transmission shaft and the impeller;

FIG. 17 is a schematic structural diagram of the limit connection between the first transmission shaft and the impeller.

### IN THE FIGURES

100. Hydrodynamic bathing shower;
1000, Main body shell; 1001, Water inlet channel; 1002, Water outlet channel; 1003, First external thread; 1004, First water outlet; 1005, Second water outlet; 1006, Handle; 1007, Switch; 1008, Through hole; 1009, Second external thread; 1010, Switch lever; 1011, Cap; 1012, First sealing plug; 1013, Second sealing plug; 1014, Cover; 1015, Water outlet; 1016, Second protrusion;
2000, Driving component; 2001, Gear transmission mechanism; 2002, Impeller; 2003, Connecting part; 2004, Blades; 2005, Gear box; 2006, First protrusion; 2007, First gear transmission part; 2008, Second gear transmission part; 2009, Gear transmission shaft; 2010, First transmission shaft; 2011, First spur gear; 2012, First gear part; 2013, First post; 2014, Second gear part; 2015, Gear fixing part; 2016, Second spur gear; 2017, Second post; 2018, First bearing; 2019, Second bearing; 2020, Third bearing; 2021, Spur internal gear; 2022, Foolproof post; 2023, First limiting part; 2024, Buckle; 2025, Threaded hole; 2026, Second limiting groove; 2027, Second limiting part;
3000, Cleaning components; 3001, Shower head; 3002, Brush head; 3003, First internal thread; 3004, U-shaped washer; 3005, First limiting groove; 3006, Clamping hole.

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

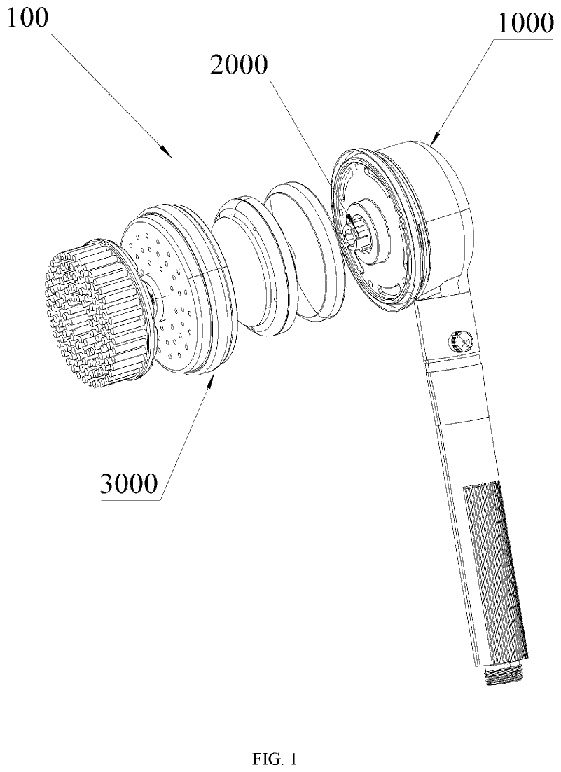

The present invention provides a hydrodynamic bathing shower 100, as shown in FIG. 1, which includes a main body shell 1000, a driving component 2000 arranged inside the main body shell 1000, and a cleaning component 3000 detachably attached to the main body shell 1000.

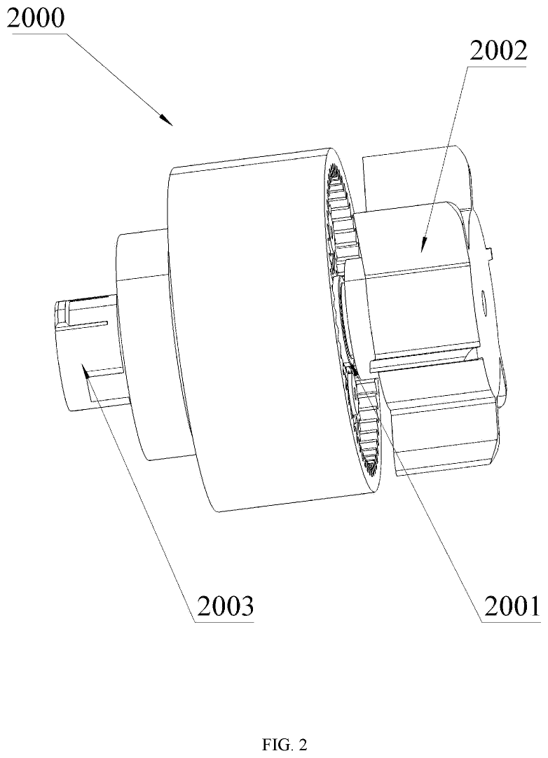

In this embodiment, as shown in FIG. 2, the driving component 2000 includes a gear transmission mechanism 2001, an impeller 2002 and a connecting part 2003, wherein the impeller 200 and the gear transmission mechanism 2001 form a transmission connection, and the gear transmission mechanism 2001 forms a transmission connection with the cleaning component 3000 through the connecting part 2003.

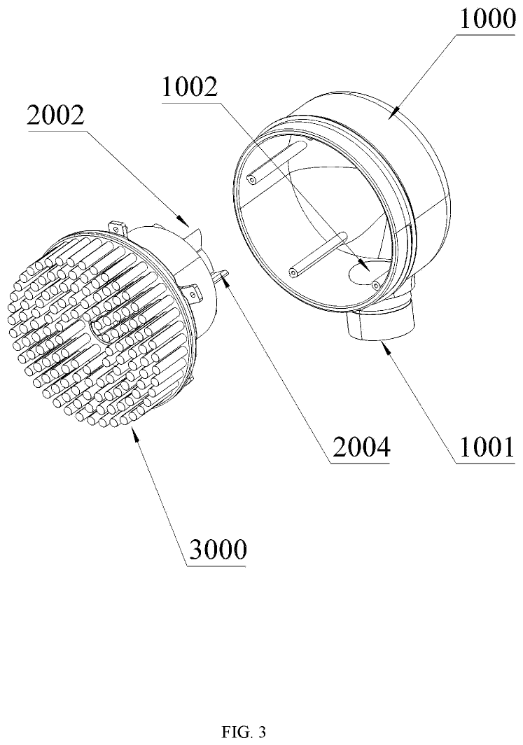

In this embodiment, as shown in FIG. 3, the main body shell 1000 is provided with at least one water inlet channel 1001 and at least one water outlet channel 1002, and the impeller 2002 is arranged in the water outlet channel 1002, wherein the water flow direction of the water inlet channel 1001 is towards the blades 2004 of the impeller 2002, and when the external water source flows towards the water outlet channel 1002 through the water inlet channel 1001, the impeller 2002 will be driven to rotate by the water flow.

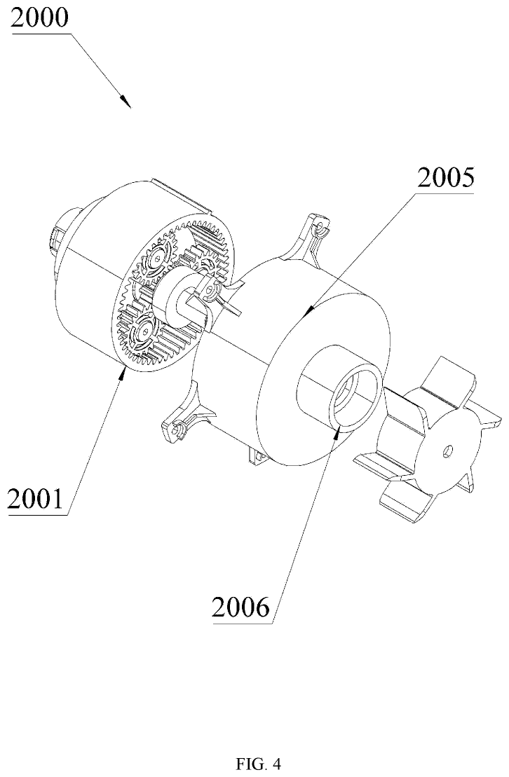

In this embodiment, as shown in FIG. 4, the driving component 2000 further includes a gear box 2005, which is sleeved outside the gear transmission mechanism 2001, wherein the central position of the gear box 2005 is provided with a first protrusion 2006 with a hollow cylindrical structure, and the existence of the gear box 2005 can effectively protect the gear transmission mechanism 2001 from dust and other impurities, thereby prolonging its service life. At the same time, the hollow cylindrical structure of the first protrusion 2006 can provide additional space for subsequent installation of other components or maintenance and inspection. This design makes the gear transmission mechanism more stable and durable, and also facilitates maintenance and overhaul.

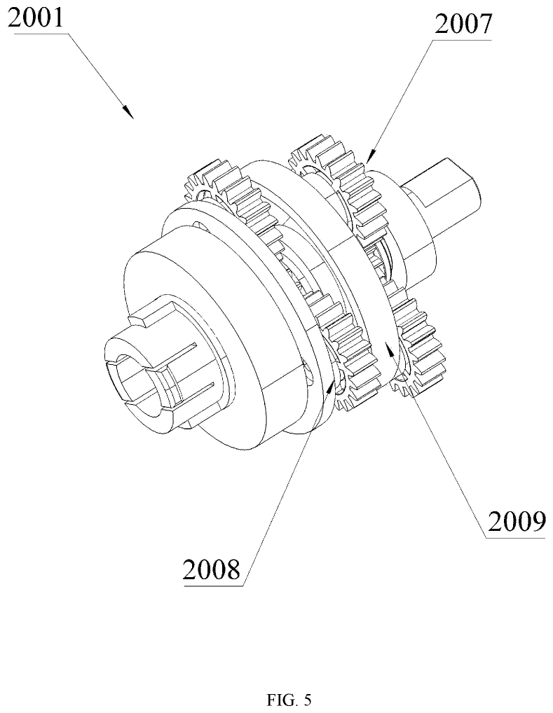

In this embodiment, as shown in FIG. 5, the gear transmission mechanism 2001 includes a first gear transmission part 2007 and a second gear transmission part 2008, wherein the first gear transmission part 2007 and the second gear transmission part 2008 are in transmission connection through a gear transmission shaft 2009, and through the cooperation of the two gear transmission parts, more efficient force transmission can be realized, thereby improving the working efficiency of the whole mechanical system. The two gear transmission parts work independently, and their configurations or proportions can be adjusted as needed to adapt to different working conditions or requirements. The stability and reliability of the system can be increased by connecting the two gear transmission parts through the gear transmission shaft, and the downtime of the system caused by the failure of a single component can be reduced.

In other embodiments (not shown in the figure), the gear transmission mechanism 2001 may include a first gear transmission part, a second gear transmission part and a third gear transmission part. The first gear transmission part and the second gear transmission part are connected through the first gear transmission shaft, and at the same time, the second gear transmission part and the third gear transmission part are also connected through the second gear transmission shaft. By arranging a plurality of gear transmission parts, more complex transmission modes can be provided to meet more diversified requirements.

In other embodiments (not shown), the gear transmission mechanism 2001 may include a motor and a reducer. The output shaft of the motor is connected with the input shaft of the reducer through the first transmission shaft. The output shaft of the reducer is connected with the first gear transmission part through the second transmission shaft. This design can use the high-speed rotation provided by the motor to convert it into low-speed and high-torque rotation through the reducer to drive a larger load.

In other embodiments (not shown in the figure), the gear transmission mechanism 2001 may include a hydraulic motor and a hydraulic pump, wherein the output shaft of the hydraulic motor is connected with the input shaft of the hydraulic pump through a first transmission shaft, and the output end of the hydraulic pump is connected with the first gear transmission part through a hydraulic pipeline. This design can utilize the high-pressure liquid provided by the hydraulic motor to convert it into high-speed rotation through the hydraulic pump to drive a larger load.

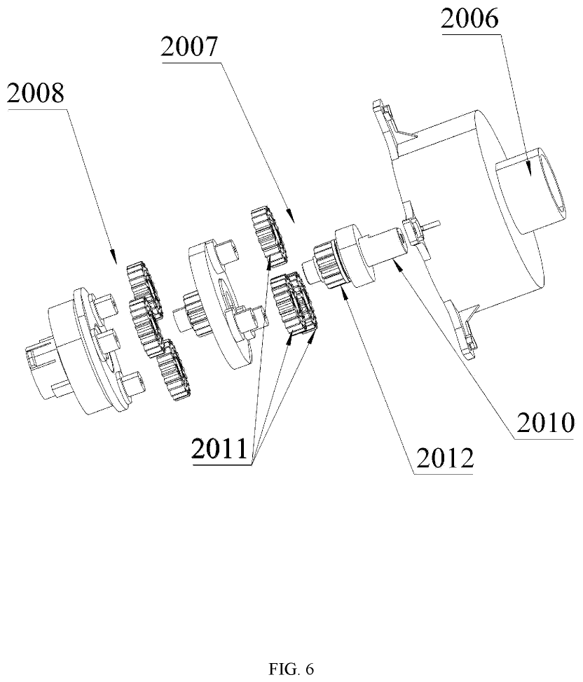

In this embodiment, as shown in FIG. 6, the first gear transmission part 2007 includes a first transmission shaft 2010 and three first spur gears 2011. The first transmission shaft 2010 is provided with the first gear part 2012, and the first transmission shaft 2010 penetrates through the first protrusion 2006 and forms a transmission connection with the impeller 2002. By providing the three first spur gears 2011 on the first transmission shaft 2010, not only can more efficient power transmission be realized, but also a variety of different transmission modes can be realized, which improves the adaptability and flexibility of the shower device.

In other embodiments (not shown in the figure), four first spur gears 2011 can be provided, or any other desired number can be provided. This design can provide more complicated transmission modes to meet more diversified work requirements. In other embodiments (not shown in the figure), the first transmission shaft 2010 is provided with a first gear part with a clutch, and the first transmission shaft penetrates through the first protrusion and forms a transmission connection with the impeller, and the clutch can disconnect or connect the two gears as required, thus providing greater control flexibility.

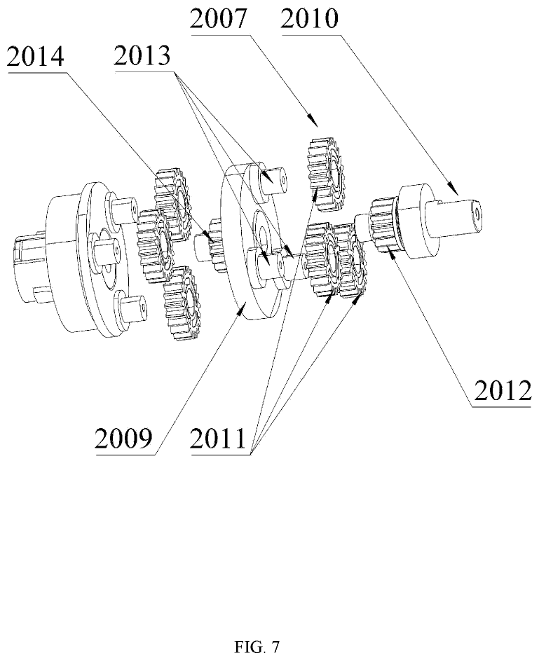

In this embodiment, as shown in FIG. 7, one end of the gear transmission shaft 2009 is provided with three first posts 2013, and the other end is also provided with a second gear part 2014, wherein the first spur gear 2011 is fixed on the gear transmission shaft 2009 through the first posts 2013 and is meshed with the first gear part 2012. The first spur gear 2011 is fixed by providing the three first posts 2013 on the gear transmission shaft 2009, which can ensure the stable meshing between the first spur gear 2011 and the first gear part 2012, thus improving the stability and efficiency of transmission.

In other embodiments (not shown in the figure), the first posts 2013 can be arranged in four or in any other desired number, so as to provide a more complicated transmission mode to meet diversified use requirements.

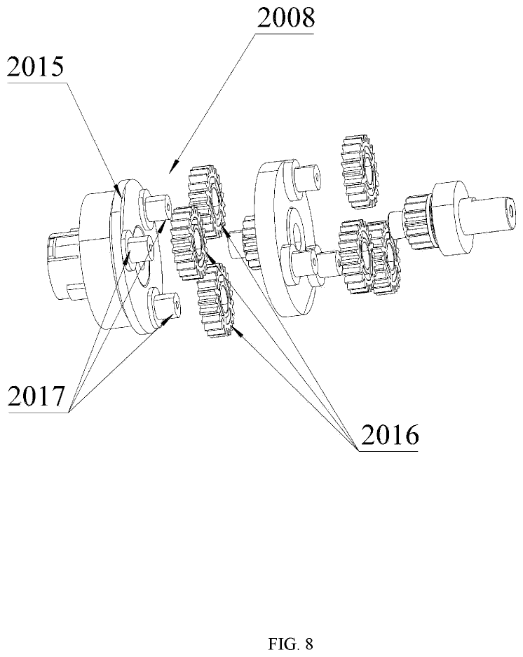

In this embodiment, as shown in FIG. 8, the second gear transmission part 2008 includes a gear fixing part 2015 and three second spur gears 2016, one end of the gear fixing part 2015 is provided with three second posts 2017, and the second spur gears 2016 are fixed on the gear fixing part 2015 through the second posts 2017 and are meshed with the second gear part 2014. By fixing the second spur gear 2016 with the second post 2017 on the gear fixing part 2015, the stable meshing between the second spur gear 2016 and the second gear part 2014 can be ensured, thus improving the stability and efficiency of transmission. In addition, by using three second spur gears 2016, more complicated transmission modes can be realized to meet more diversified work requirements, and the reliability and working efficiency of the shower device can be effectively improved. In addition, by using three second spur gears 2016, more complicated transmission modes can be realized to meet more diversified work requirements, and the reliability and working efficiency of the shower device can be effectively improved.

In other embodiments (not shown in the figure), the second gear transmission part 2008 may include four second spur gears 2016 or be configured in any other desired number, and the gear fixing part 2015 may also be provided with four second posts 2017 or be configured in any other desired number, thus providing a more complicated transmission mode and satisfying the diversity of use of the shower device.

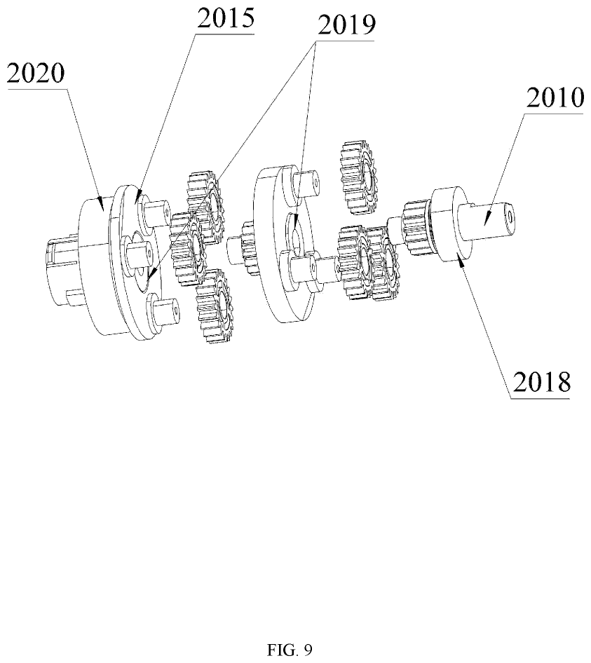

In this embodiment, as shown in FIG. 9, a first bearing 2018 is arranged on the first transmission shaft 2010, a second bearing 2019 is arranged in the gear transmission shaft 2009 and the gear fixing part 2015, and a third bearing 2020 is arranged between the gear fixing part 2015 and the connecting part 2003. By arranging the bearings, the friction can be effectively reduced, the service life of the shower device is prolonged, and at the same time, the shower device is effectively prolonged.

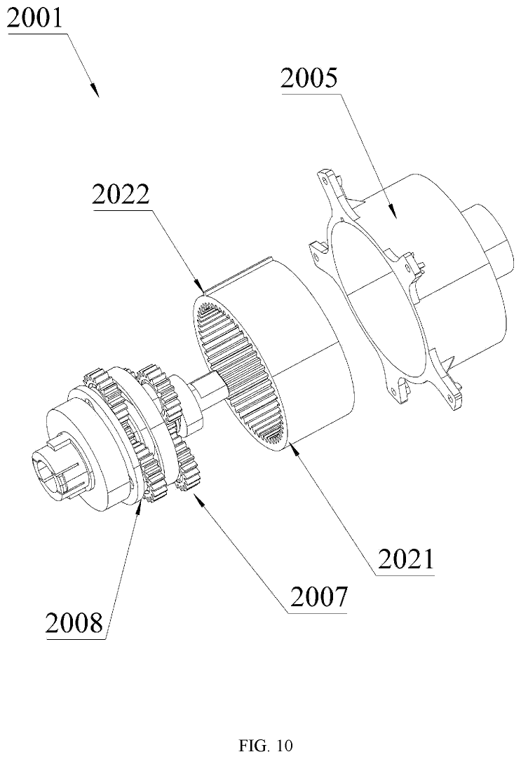

In this embodiment, as shown in FIG. 10, the gear transmission mechanism 2001 further includes a spur internal gear 2021, which is fixed in the gear box 2005 through a foolproof post 2022, and the first gear transmission part 2007 and the second gear transmission part 2008 are meshed with each other, so that efficient and accurate transmission can be realized by using the spur internal gear 2021. The tooth line of the spur internal gear 2021 is parallel to the axis, so the length of the contact line between the two meshing gears is unchanged during the transmission process, which makes the transmission more stable and the noise lower. In addition, the stability of the spur internal gear 2021 in the gear box 2005 can be ensured by fixing the spur internal gear 2021 by the foolproof post 2022, which can prevent the displacement caused by vibration or impact. In addition, this design also enables the maintenance of the shower device.

In other embodiments (not shown in the figure), the gear transmission mechanism 2001 may also include two spur internal gears 2021, the first gear transmission part 2007 is meshed with one of the spur internal gears 2021, and the second gear transmission part 2008 is meshed with the other spur internal gear 2021. By setting two spur internal gears 2021, more complicated transmission modes can be realized, so as to meet more diversification. The design of two spur internal gears 2021 can make each gear transmission part work independently, which makes the subsequent maintenance more convenient. When one gear transmission part has problems, it can be repaired or replaced independently without affecting the normal work of other parts.

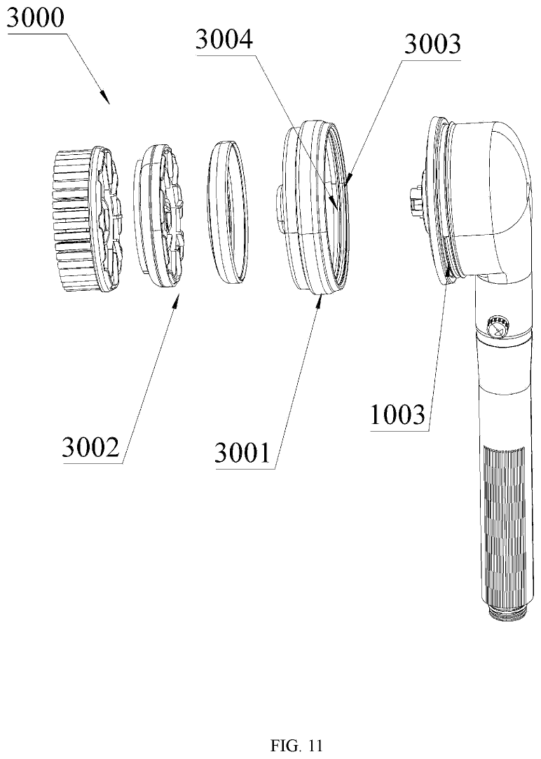

In this embodiment, as shown in FIG. 11, the cleaning component 3000 includes a shower head 3001 and a brush head 3002, wherein the shower head 3001 is provided with a first internal screw thread 3003, the main body shell 1000 is provided with a first external screw thread 1003, and the shower head 3001 and the main body shell 1000 are fixedly connected through the first internal screw thread 3003 and the first external screw thread 1003. The shower head 3001 is also internally provided with a U-shaped washer 3004. Through the cooperation of internal and external threads, the shower head 3001 can be conveniently installed on the main body shell 1000 or disassembled, so that the shower head 3001 can be conveniently cleaned or replaced. The U-shaped washer 3004 can provide a good sealing effect and prevent water or other liquids from flowing from the shower head 3001 and the main body shell 1000.

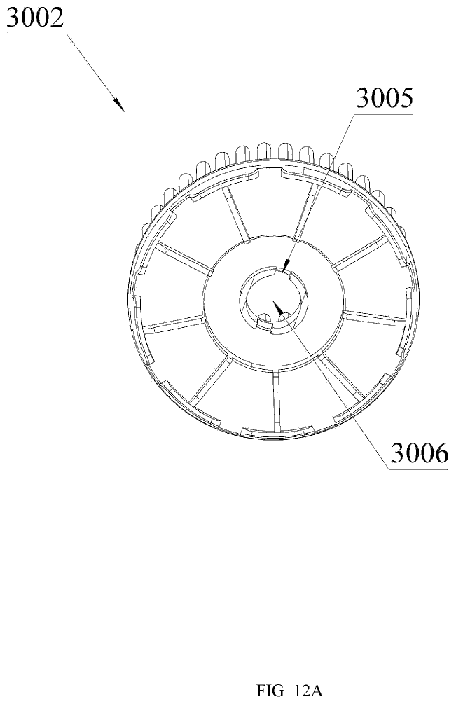

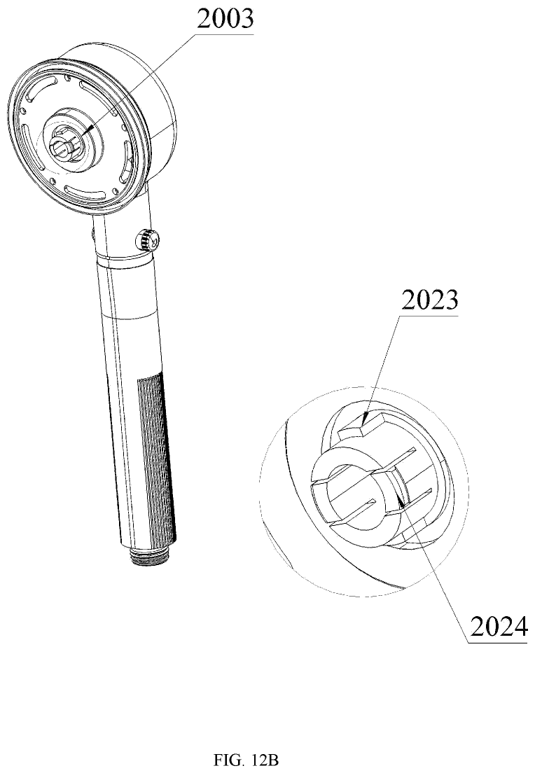

In this embodiment, as shown in FIGS. 12A-12B, the brush head 3002 is provided with a first limiting groove 3005 and a clamping hole 3006, and the connecting part 2003 is provided with a first limiting part 2023 and a buckle 2024. The connecting part 2003 penetrates through the clamping hole 3006, the buckle 2024 is connected and matched with the clamping hole 3006, and the first limiting part 2023 is inserted into and matched with the first limiting groove 3005. Buckle connection can ensure the stable connection between the connecting part 2003 and the brush head 3002, prevent the brush head 3002 from accidentally falling off during use, and facilitate the replacement of other cleaning components 3000 for bathing. The insertion and matching of the first limiting part 2023 and the first limiting groove 3005 can accurately control the position of the brush head 3002 and prevent the brush head 3002 from shifting during use. This design makes the installation and disassembly of the brush head 3002 very convenient, and users can easily replace it as needed. In this embodiment, the brush head 3002 includes one or more of a bathing brush head, a bathing mud cloth head and a peeling brush head.

In other embodiments (not shown in the figure), the connecting part 2003 is provided with springs and buckles, the brush head 3002 is provided with spring grooves and clamping holes, the connecting part 2003 penetrates through the clamping holes, the buckles are connected and matched with the clamping holes, and the springs are inserted and matched with the spring grooves. This design can provide better elasticity and make the brush head more flexible in use. In other embodiments (not shown in the figure), the connecting part 2003 is provided with a rotating part and a buckle, the brush head 3002 is provided with a rotating groove and a clamping hole, the connecting part 2003 penetrates through the clamping hole, the buckle is connected and matched with the clamping hole, and the rotating part is inserted and matched with the rotating groove. This design can make the brush head rotate during use and provide better cleaning effect.

In other embodiments (not shown in the figure), the connecting part 2003 is provided with a magnetic part and a buckle, the brush head 3002 is provided with a magnetic groove and a clamping hole, the connecting part 2003 penetrates through the clamping hole, the buckle is connected and matched with the clamping hole, and the magnetic part is inserted and matched with the magnetic groove. This design can be connected by magnetic force, which makes the brush head easier to install and disassemble.

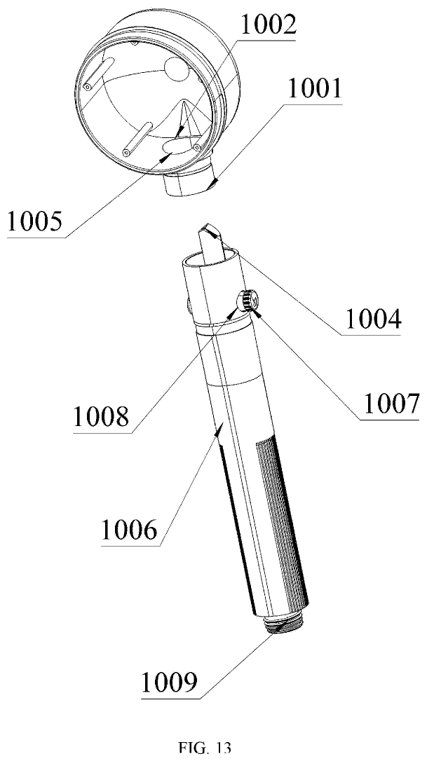

In this embodiment, as shown in FIG. 13, the water inlet channel 1001 further includes a first water inlet 1004 and a second water inlet 1005, wherein the diameter of the first water inlet 1004 is smaller than that of the second water inlet 1005, thereby increasing the speed and pressure of water flow and providing greater power for driving the impeller 2002. The water inlet channel 1001 is also connected with a handle 1006. The handle 1006 is provided with a switch 1007 for controlling the water outlet of the first water inlet 1004. The handle 1006 is provided with a through hole 1008, and the switch 1007 penetrates through the through hole 1008. The lower end of the water inlet channel 1001 is provided with a second external thread 1009, which can be connected with an external water source through a thread, so that the shower device can supply water. The handle 1006 is also provided with an anti-slip texture, which can prevent users from slipping during using.

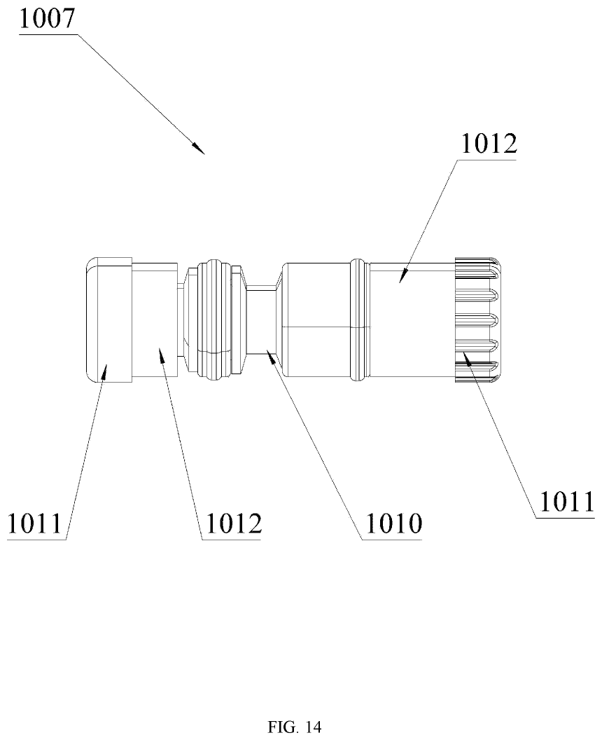

In this embodiment, as shown in FIG. 14, the switch 1007 includes a switch lever 1010 and a cap 1011, wherein the cap 1011 is arranged at both ends of the switch lever 1010, and the switch lever 1010 is respectively provided with a first sealing plug 1012 and a second sealing plug 1013, which can effectively prevent liquid or gas from entering through the through hole, thereby improving the sealing performance of the handle 1006 and the switch 1007. The cap 1011 can protect the switch 1007 from being damaged by the external environment, thus improving the durability of the shower device and making the whole shower device more beautiful and elegant.

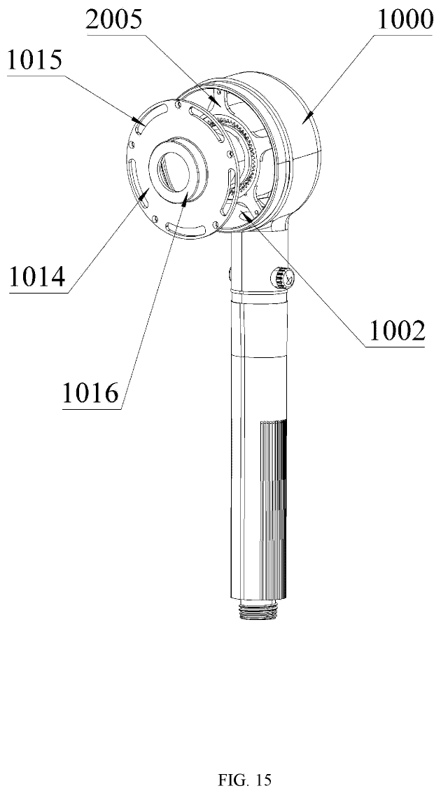

In this embodiment, as shown in FIG. 15, the main body shell 1000 further includes a cover 1014, which is fixedly connected with the gear box 2005 through bolt connection, so that the driving component 2000 is fixed inside the main body shell 1000, wherein the cover 1014 is provided with five water outlets 1015, and water flows out from the water outlets 1015 through the water outlet channel 1002. The center of the cover 1014 is provided with a second protrusion 1016, wherein the second protrusion 1016 has a hollow cylindrical structure, and the receiving part 2003 penetrates through the second protrusion 1016 and protrudes outward to form a detachable connection with the cleaning component 3000.

In other embodiments (not shown), the cover 1014 and the gear box 2005 can be fixedly connected by welding, which can provide stronger structural stability. In other embodiments (not shown in the figure), the cover 1014 and the gear box 2005 can be fixedly connected by a buckle, so that the component and disassembly can be facilitated.

In other embodiments (not shown in the figure), the cover 1014 can also be provided with six water outlets 1015 or any other desired number, so as to increase the water output of the shower device.

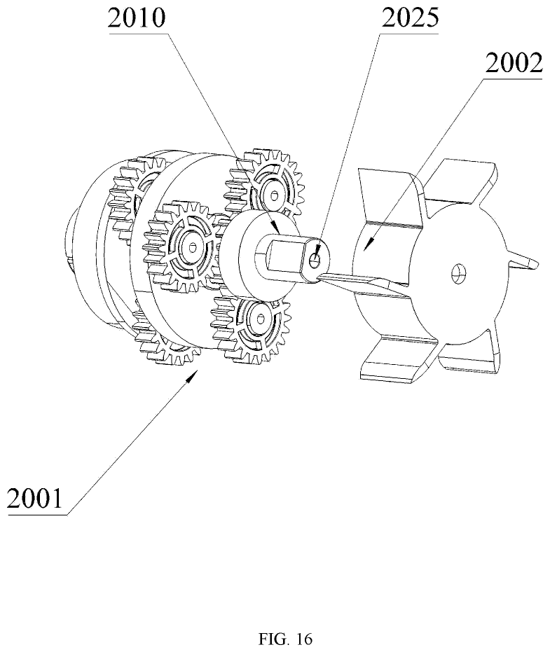

In this embodiment, as shown in FIG. 16, the first transmission shaft 2010 is provided with a threaded hole 2025, and the impeller 2002 is fixedly connected with the first transmission shaft 2010 through bolt connection, thus forming a transmission connection with the gear transmission mechanism 2001, thus achieving more efficient power transmission and improving the working efficiency and stability of the whole system.

In other embodiments (not shown in the figure), in addition, one end of the first transmission shaft 2010 can be provided with a keyway, and the impeller 2002 and the first transmission shaft 2010 can be connected by a key, which can provide higher torque transmission efficiency.

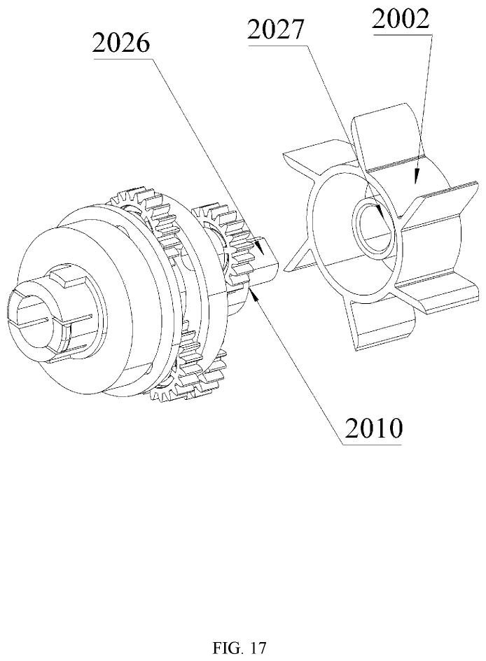

In this embodiment, as shown in FIG. 17, the first transmission shaft 2010 is provided with a second limiting groove 2026, and the impeller 2002 is internally provided with a second limiting part 2027. The second limiting groove 2026 and the second limiting part 2027 cooperate with each other to limit the rotation of the first transmission shaft 2010, so as to accurately control the rotation of the impeller 2002 and improve the stability and reliability of the whole system.

In this embodiment, the main body shell 1000 and the driving component 2000 are both made of plastic. In other embodiments (not shown in the figure), ABS engineering plastic can be selected as the material of the shower device. ABS engineering plastic has high impact strength, stability and wear resistance, and it is resistant to water, inorganic acid, alkali and salt corrosion, and has good weldability and formability.

The present invention also provides a bathing method, including providing a hydrodynamic bathing shower 100, which comprises a main body shell 1000, a driving component 2000 arranged inside the main body shell 1000, and a cleaning component 3000 detachably attached to the main body shell 1000.

In this embodiment, the driving component 2000 includes a gear transmission mechanism 2001, an impeller 2002 and a connecting part 2003, wherein the impeller 2002 and the gear transmission mechanism 2001 form a driving connection, and the gear transmission mechanism 2001 forms a driving connection with the cleaning component 3000 through the connecting part 2003; the main body shell 1000 is provided with at least one water inlet channel 1001 and at least one water outlet channel 1002, and the impeller 2002 is arranged in the water outlet channel 1002, wherein the water flow direction of the water inlet channel 1001 faces the blades 2004 of the impeller 2002; when the external water source flows through the water inlet channel 1001 toward the water outlet channel 1002, the impeller 2002 will be driven to rotate by the water flow, thereby driving the cleaning component 3000 to rotate.

In this embodiment, the method includes: installing the hydrodynamic bathing shower 100 in a suitable position; connecting the hydrodynamic bathing shower 100 with an external water source; turning on the water source to make the water flow from the water outlet channel 1002 to the blades 2004, and the blades 2004 rotating under the action of the water flow, thus driving the gear transmission mechanism 2001 and the cleaning component 3000 to rotate, and the water flow being sprayed from the cleaning component 3000 for bathing while showering the water; turning off the water supply after use.

The technical means disclosed in the solution of the present invention are not limited to the technical means disclosed in the above embodiments, but also include the technical solution composed of any combination of the above technical features. It should be pointed out that for those skilled in the art, several improvements and embellishments can be made without departing from the principle of the present invention, and these improvements and embellishments are also regarded as the protection scope of the present invention.

What is claimed is:

1. A hydrodynamic bathing shower, comprising:
a main body shell, a driving component arranged inside said main body shell, and a cleaning component detachably attached to said main body shell; and
wherein, said driving component comprises a gear transmission mechanism, an impeller and a connecting part, wherein said impeller and said gear transmission mechanism form a transmission connection, and said gear transmission mechanism forms a transmission connection with said cleaning component through said connecting part; and
wherein, said main body shell is provided with at least one water inlet channel and at least one water outlet channel, and said impeller is arranged in said water outlet channel, wherein a water flow direction of said water inlet channel faces blades of said impeller; and
wherein, when an external water source flows towards said water outlet channel through said water inlet channel, said impeller will be driven to rotate by the water flow, thereby driving said cleaning component to rotate.

2. The hydrodynamic bathing shower according to claim 1, wherein said driving component further comprises a gear box, and said gear box penetrates outside said gear transmission mechanism, and a central position of said gear box is provided with a first protrusion, wherein said first protrusion has a hollow cylindrical structure.

3. The hydrodynamic bathing shower according to claim 1, wherein said gear transmission mechanism comprises a first gear transmission part and a second gear transmission part, and said first gear transmission part and said second gear transmission part are in transmission connection through a gear transmission shaft.

4. The hydrodynamic bathing shower according to claim 3, wherein said first gear transmission part comprises a first transmission shaft and at least one first spur gear, said first transmission shaft is provided with a first gear part, and said first transmission shaft penetrates through said first protrusion and forms a transmission connection with said impeller.

5. The hydrodynamic bathing shower according to claim 4, wherein one end of said gear transmission shaft is provided with at least one first post, and the other end is provided with a second gear part, wherein said first spur gear is fixed on said gear transmission shaft through said first post and is meshed with said first gear part.

6. The hydrodynamic bathing shower according to claim 5, wherein said second gear transmission part comprises a gear fixing part and at least one second spur gear, and one end of said gear fixing part is provided with at least one second post, wherein said second spur gear is fixed on said gear fixing part through said second post and is meshed with said second gear part.

7. The hydrodynamic bathing shower according to claim 6, wherein a first bearing is arranged on said first transmission shaft, a second bearing is arranged between said gear transmission shaft and said gear fixing part, and a third bearing is arranged between said gear fixing part and said connecting part.

8. The hydrodynamic bathing shower according to claim 1, wherein said gear transmission mechanism further comprises a spur internal gear, which is fixed in said gear box through a foolproof post, and said first gear transmission part and said second gear transmission part are meshed with said spur internal gear.

9. The hydrodynamic bathing shower according to claim 1, wherein said cleaning component comprises a shower and a brush head, wherein said shower is provided with a first internal thread, and said main body shell is provided with a first external thread, and said shower and said main body shell are fixedly connected through threads, and a U-shaped washer is arranged inside said shower.

10. The hydrodynamic bathing shower according to claim 9, wherein said brush head is provided with a first limiting groove and a clamping hole, said connecting part is provided with a first limiting part and a buckle, said connecting part penetrates through said clamping hole, said buckle is connected and matched with said clamping hole, and said first limiting part is inserted and matched with said first limiting groove.

11. The hydrodynamic bathing shower according to claim 10, wherein said brush head comprises one or more of a bathing brush head, a bathing mud cloth head and a peeling brush head.

12. The hydrodynamic bathing shower according to claim 1, wherein said water outlet channel comprises a first water inlet and a second water inlet, a handle is connected to said water inlet channel, and a switch for controlling the water outlet of said first water inlet is arranged on said handle.

13. The hydrodynamic bathing shower according to claim 12, wherein said handle is provided with a through hole, said switch passes through said through hole, and a lower end of said water inlet channel is provided with a second external thread.

14. The hydrodynamic bathing shower according to claim 13, wherein said switch comprises a switch lever and a cap, wherein said cap is arranged at both ends of said switch lever, and said switch lever is respectively provided with a first sealing plug and a second sealing plug.

15. The hydrodynamic bathing shower according to claim 1, wherein said main body shell further comprises a cover, and said cover is fixedly connected with said gear box through bolt connection, so that said driving component is fixed inside said main body shell, wherein at least one water outlet is arranged on said cover, and a second protrusion is arranged at the center of said cover, wherein said second protrusion has a hollow cylindrical structure, and said connecting part penetrates through said second protrusion and extends outwards to form a detachable connection with said cleaning component.

16. The hydrodynamic bathing shower according to claim 1, wherein said first transmission shaft is provided with a threaded hole, and said impeller is fixedly connected with said first transmission shaft through bolt connection, thus forming a transmission connection with said gear transmission mechanism.

17. The hydrodynamic bathing shower according to claim 16, wherein said first transmission shaft is provided with a second limiting groove, and said impeller is internally provided with a second limiting part, and said second limiting groove and said second limiting part are mutually matched.

18. A hydrodynamic bathing shower, comprising:
a main body shell, a driving component arranged inside said main body shell, and a cleaning component detachably attached to said main body shell; and
wherein, said driving component comprises a gear transmission mechanism, an impeller and a connecting part, wherein said gear transmission mechanism comprises at least one gear transmission part and a gear box, and said gear transmission part is sleeved in said gear box, wherein said gear transmission part comprises at least one gear and at least one gear transmission shaft, wherein one end of said gear transmission shaft is fixedly connected with said impeller to form a transmission connection with said gear transmission mechanism, and the other end of said gear transmission shaft is provided with a connecting part, said gear transmission mechanism forms a transmission connection with said cleaning component through said connecting part; and
wherein, said main body shell is provided with at least one water inlet channel and at least one water outlet channel, and said impeller is arranged in said water outlet channel, wherein a water flow direction of said water inlet channel faces blades of said impeller; and
wherein, when an external water source flows towards said water outlet channel through said water inlet channel, said impeller will be driven to rotate by the water flow, thereby driving said cleaning component to rotate.

19. The hydrodynamic bathing shower according to claim 18, wherein said main body shell and said driving component are both made of plastic.

20. A bathing method, comprising providing a hydrodynamic bathing shower, comprising a main body shell, a driving component arranged inside said main body shell, and a cleaning component detachably attached to said main body shell; and
wherein, said driving component comprises a gear transmission mechanism, an impeller and a connecting part, wherein said impeller and said gear transmission mechanism form a transmission connection, and said gear transmission mechanism forms a transmission connection with said cleaning component through said connecting part; and
wherein, said main body shell is provided with at least one water inlet channel and at least one water outlet channel, and said impeller is arranged in said water outlet channel, wherein a water flow direction of said water inlet channel faces blades of said impeller; and
wherein, when an external water source flows towards said water outlet channel through said water inlet channel, said impeller will be driven to rotate by the water flow, thereby driving said cleaning component to rotate; and
the method comprises the following steps:
installing said hydrodynamic bathing shower at a proper position; and
communicating said hydrodynamic bathing shower with an external water source; and
turning on the water source to make the water flow from said water outlet channel to said blades, and said blades rotating under the action of the water flow, so as to drive said gear transmission mechanism and said cleaning component to rotate, and the water flow being sprayed outwards from said cleaning component, so as to perform bathing while showering; and
turning off the water source after use.
